(19) United States
(12) Patent Application Publication
(10) Pub. No.: US 2023/0265671 A1
(43) Pub. Date: Aug. 24, 2023

(54) Illuminated Portable Bathroom

(71) Applicants: Eric Andrew Jensen, Elko New Market, MN (US); Michael William Jensen, Savage, MN (US)

(72) Inventors: Eric Andrew Jensen, Elko New Market, MN (US); Michael William Jensen, Savage, MN (US)

(21) Appl. No.: 17/677,386

(22) Filed: Feb. 22, 2022

(51) Int. Cl. E04H 1/12; F21S 9/03; F21V 33/00

(52) U.S. Cl. CPC E04H 1/1216; F21S 9/03; F21V 33/004; F21Y 2115/10

(57) ABSTRACT

An illuminated portable bathroom includes a bathroom body and a door. The bathroom body is configured to provide a safe, contained space with the features necessary for a user to manage their waste. The door is equipped with an occupancy indicator and a lock, such that adjusting the lock toggles the open or closed status display upon the occupancy indicator. An electrical power supply attached to the bathroom body, preferably upon the roof of the bathroom body, provides electricity necessary for the activation of a set of lights. The electrical power supply may utilize solar panels or other energy sources to generate power for subsequent distribution. The lights may be positioned adjacent to the occupancy indicator, thus allowing users to easily identify whether the bathroom body is occupied in any ambient lighting circumstances. The lights may also be arranged within the bathroom body to improve the comfort of users within.

### FIELD OF THE INVENTION

The present invention relates generally to public facilities. More specifically, the present invention relates to a portable toilet device equipped with various lighting fixtures that improves usability in poor lighting conditions.

### BACKGROUND OF THE INVENTION

Public spaces used for events, projects, construction, and more are often ill-equipped to support human needs for an extended period of hours or days. This is often due to the temporary nature of the events and projects. Facilities, particularly restrooms with proper plumbing, may not be available at a work site in which plumbing and other essential housing features are being established, or at an open event venue that requires management of all available space for stages, concessions stands and more. This presents a problem for any person who is required to be at a site for any extended duration. The portable bathroom was developed to provide relief from some of these issues. Such structures provide the toilet, sanitization means, and privacy that are necessary for safely managing human waste.

Unfortunately, these structures often fail to implement solutions that could be beneficial, even necessary, for waste management in varying conditions. Many outdoor concert-goers, outdoor enthusiasts, construction workers and more have had the unpleasant experience of attempting to use a portable bathroom at night. It is difficult to read the occupancy indicator, which often results in the disturbance of users within the portable bathroom. Cleanliness becomes more difficult to sustain, as a user cannot see the toilet rim well. Many users must resort to using flashlights to identify these features, which may make the waiting process all the more stressful. What is needed is an integrated lighting system that can illuminate the indicator outside of the portable bathroom as well as the space within the portable bathroom.

The present invention addresses this issue. An illuminated portable bathroom includes a bathroom body and a door. The bathroom body is configured to provide a safe, contained space with the features necessary for a user to manage their waste. The door is equipped with an occupancy indicator and a lock, such that adjusting the lock toggles the open or closed status display upon the occupancy indicator. An electrical power supply attached to the bathroom body, preferably upon the roof of the bathroom body, provides electricity necessary for the activation of a set of lights. The electrical power supply may utilize solar panels or other renewable energy sources to generate power for storage and subsequent distribution. The lights may be positioned adjacent to the occupancy indicator, thus allowing users to easily identify whether the bathroom body is occupied in any ambient lighting circumstances. The lights may also be arranged within the bathroom body to improve the comfort of users within.

### BRIEF DESCRIPTION OF THE DRAWINGS

FIG. 1 is a perspective view of the present invention.

FIG. 2 is a right view of the present invention.

FIG. 3 is a rear sectional view taken along line 3-3 in FIG. 2.

FIG. 4 is a front view of the present invention.

FIG. 5 is a front view of a bathroom door of the present invention.

FIG. 6 is a right sectional view taken along line 6-6 in FIG. 5.

### DETAILED DESCRIPTION OF THE INVENTION

All illustrations of the drawings are for the purpose of describing selected versions of the present invention and are not intended to limit the scope of the present invention.

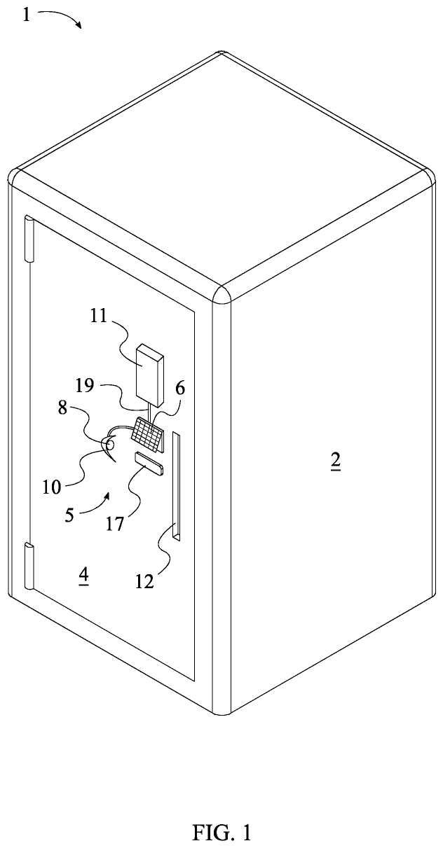

The present invention is an illuminated portable bathroom 1 that is used to provide a temporary, portable solution to management of human waste. The present invention is also configured to illuminate relevant portions of the illuminated portable bathroom 1 for convenience and ease of use. The present invention comprises a portable bathroom 1, an illumination system 5, and a handle 12, as shown in FIG. 1. The portable bathroom 1 is an enclosure, preferably equipped with a toilet, hand sanitizer dispenser, toilet paper roll holder, mirror, and other such features, which provides privacy for a user managing personal waste. The illumination system 5 is a set of electrical illumination devices features that allow for collection and distribution of both visible light and electrical power across the present invention. The handle 12 is a mechanism that facilitates grasping and subsequent operation of the portable bathroom 1.

The general configuration of the aforementioned components allows the present invention to efficiently and effectively provide an illuminated, temporary human waste management space. The portable bathroom 1 may comprise a bathroom enclosure 2 and a bathroom door 4, as shown in FIG. 1. The bathroom enclosure 2 is the privacy-providing receptacle in which, in the preferred usage of the present invention, a user would manage their personal hygiene and relieve themselves of waste. The bathroom door 4 is a panel which swings to provide or restrict access to the bathroom enclosure 2. The illumination system 5 may comprise a primary power supply 6 and a plurality of lights 7. The primary power supply 6 denotes the storage devices and other electronic components, including any or all of power generation devices, wiring, resistors, switches, logical components, and more necessary to provide electrical power to the plurality of lights 7. The plurality of lights 7 is a set of electrically-powered light sources, such as light-emitting diodes (LEDs), fluorescent bulbs, incandescent bulbs, halogen bulbs, light strips, and more that enhance visibility of desirable areas. The plurality of lights 7 may comprise at least one handle light 8 and at least one internal light 9. The at least one handle light 8 is a fixture positioned and oriented in such a manner as to enhance the visibility of the handle 12. The at least one internal light 9 is the light that illuminates the space within the bathroom enclosure 2. The bathroom door 4 may be hingedly connected to the bathroom enclosure 2. This arrangement allows a user to swing the bathroom door 4 in order to open or close the bathroom enclosure 2 as desired. The handle 12 may be mounted onto the bathroom door 4. Thus, the user may utilize the handle 12 to adjust the position of the bathroom door 4 relative to the bathroom enclosure 2. The plurality of lights 7 may be connected onto the portable bathroom 1. In this way, the plurality of lights 7 may provide lighting adjacent to the portable bathroom 1. The at least one handle light 8 may be positioned adjacent to the handle 12. This arrangement allows the at least one handle light 8 to illuminate the handle 12 when active. An emission axis of the at least one handle light 8 may be oriented towards the handle 12. In this way, light from the at least one handle light 8 may illuminate the handle 12 alone, rather than shining directly into the face of a user. The at least one internal light 9 may be positioned within the bathroom enclosure 2. Thus, the bathroom enclosure 2 may be illuminated by the at least one internal light 9 when activated. The primary power supply 6 may be mounted onto the portable bathroom 1. This arrangement ensures that the primary power supply 6 is in appropriate proximity to components requiring electrical power. The primary power supply 6 may be electrically connected to the plurality of lights 7. Thus, the primary power supply 6 is capable of providing necessary power to the plurality of lights 7.

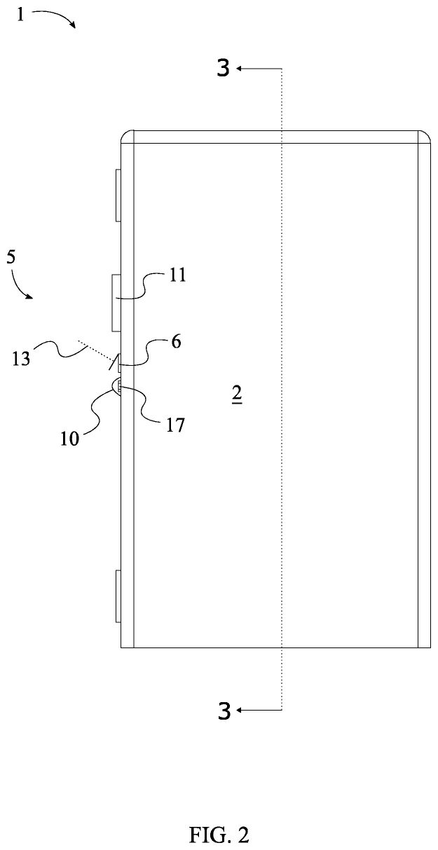

It may be advantageous to allow the illumination system 5 to generate electrical power from renewable sources. To this end, the primary power supply 6 may be a plurality of solar panels. The plurality of solar panels is a set of photovoltaic devices and associated electrical components capable of converting solar energy into electrical power. The plurality of solar panels may be externally mounted to the bathroom enclosure 2. This arrangement allows the plurality of solar panels to collect sunlight from outside the bathroom enclosure 2. Furthermore, each of the plurality of solar panels may be oriented at an optimum solar angle 13 from the portable bathroom 1, as shown in FIG. 2. In this way, the plurality of solar panels may maximize flux of solar rays, thereby maximizing power collection.

The plurality of lights 7 preferably makes optimal usage of available electrical power without compromising on ability to illuminate an area. To facilitate this, the plurality of lights 7 may be a plurality of LEDs. The plurality of LEDs ensure that minimal energy is spent when illuminating an area or target.

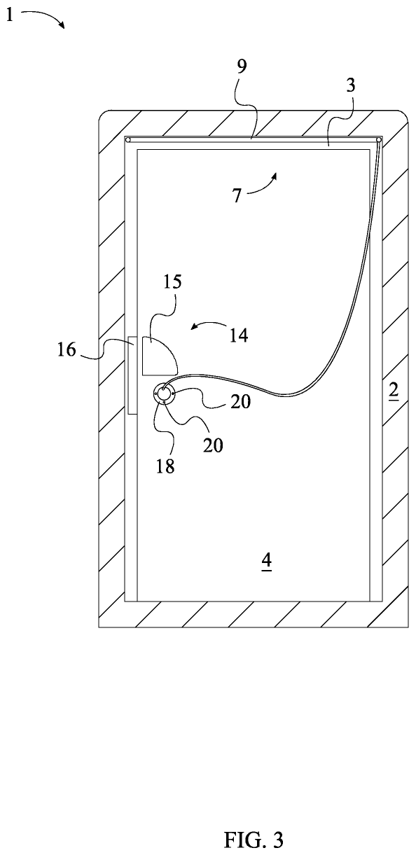

A user of the present invention may wish to secure privacy while within the bathroom enclosure 2. To enable this, the present invention may further comprise a locking mechanism 14, as shown in FIG. 3. The locking mechanism 14 is a toggleable arrangement that allows a user within the bathroom enclosure 2 to secure the bathroom door 4 in place relative to the bathroom enclosure 2. The locking mechanism 14 may comprise a first locking portion 15 and a second locking portion 16. The first locking portion 15 is a generally rigid segment that slides, rotates, or otherwise shifts relative to the second locking portion 16 in order to lock or unlock the bathroom door 4. The second locking portion 16 is a generally rigid receiver that may interact with the first locking portion 15 to toggle the locked or unlocked status of the bathroom door 4. The first locking portion 15 may be integrated into the bathroom door 4. This arrangement allows the first locking portion 15 to affect the engagement of the bathroom door 4 to the second locking portion 16. The second locking portion 16 may be integrated into the bathroom enclosure 2. Thus, the second locking portion 16 may allow the bathroom enclosure 2 to interact with the first locking portion 15. The first locking portion 15 and the second locking portion 16 may be selectively engaged to each other. In this way, the first locking portion 15 may slide, pivot, or otherwise shift in order to engage with the second locking portion 16, thereby securing or unfastening the bathroom door 4 from the bathroom enclosure 2.

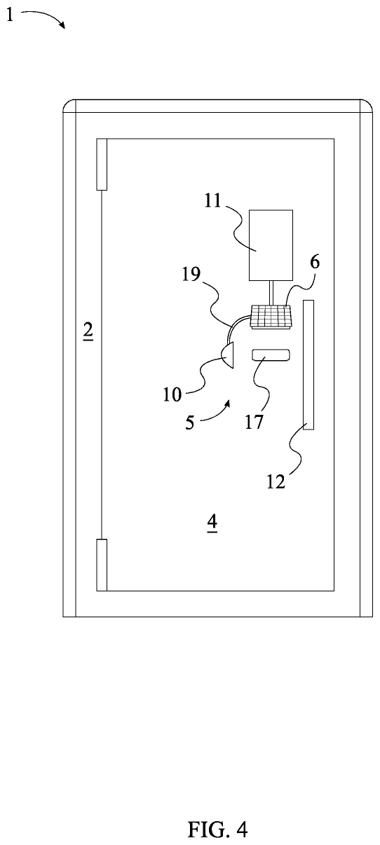

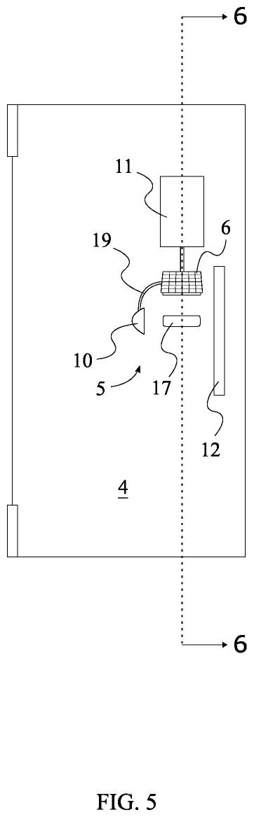

It may be further desirable to provide an indicator corresponding to the locked or unlocked status of the portable bathroom 1, thereby reducing the incidence of users being disturbed while within the bathroom enclosure 2. To this end, the locking mechanism 14 may further comprise an occupancy indicator 17, as shown in FIGS. 4 and 5. The occupancy indicator 17 is a panel, preferably color-coded, which may shift to display the locked or unlocked status of the portable bathroom 1. The occupancy indicator 17 may be mounted onto the bathroom door 4. This arrangement allows the occupancy indicator 17 to display the status of the locking mechanism 14 to passersby. The occupancy indicator 17 may be operatively integrated into the first locking portion 15. Thus, the occupancy indicator 17 may change based upon adjustment of the first locking portion 15.

The plurality of lights 7 may require additional support in order to prevent light from being directed into a user's eyes. To this end, the plurality of lights 7 may further comprise a plurality of illumination shields 10, as shown in FIGS. 4 and 5. The plurality of illumination shields 10 is a set of rigid panels which deliberately obstruct light that would otherwise blind or discomfort a user. Each of the plurality of illumination shields 10 may be mounted adjacent to a corresponding light of the plurality of lights 7. In this way, each of the plurality of illumination shields 10 prevents the corresponding light from directly illuminating a user's face.

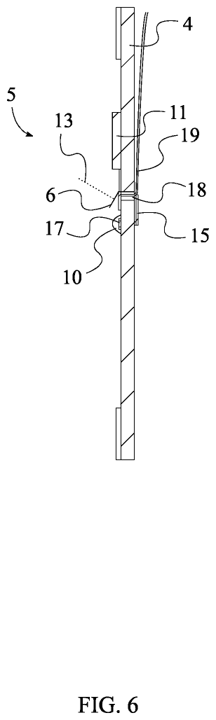

The plurality of internal lights must be able to electronically connect to the primary power supply 6. To this end, the present invention may further comprise a rigid member 18 and a light wiring 19, as shown in FIG. 6. The rigid member 18 denotes a generally tubular structure which protects the light wiring 19. The rigid member 18 may expand or contract accordion-style to fit across different widths of the bathroom door 4 on any portable bathroom 1. The light wiring 19 is a cable, cord, or set of wires which transmit electrical power from the primary power supply 6 to the plurality of lights 7, especially the at least one internal light 9. The primary power supply 6 may be terminally mounted to the rigid member 18. This arrangement ensures that the primary power supply 6 may easily communicate with the plurality of lights 7 through the rigid member 18. The at least one internal light 9 may be terminally mounted to the rigid member 18, opposite to the primary power supply 6. In this way, the at least one internal light 9 may receive electrical power from the primary power supply 6 through the rigid member 18. The rigid member 18 may traverse through the bathroom door 4. Thus, the at least one internal light 9 may receive power through the bathroom door 4. The light wiring 19 may be positioned through the rigid member 18. This arrangement allows the light wiring 19 to electrically connect components through the rigid member 18. The primary power supply 6 may be electrically connected to the at least one internal light 9 by the light wiring 19. In this way, the light wiring 19 may transfer electrical power from the primary power supply 6, through the rigid member 18, and to the at least one internal light 9.

The present invention benefits from the ability to collect reserve power, especially in the embodiment which includes the implementation of the plurality of solar panels. To this end, the illumination system 5 may further comprise a reserve power storage 11, as shown in FIG. 4. The reserve power storage 11 is a rechargeable battery that may contain reserve energy which may be utilized in the event of damage to storage components within the primary power supply 6. In an exemplary embodiment, the reserve power storage 11 may also be accessed according to need in low lighting situations, when the plurality of solar panels cannot collect light. The reserve power storage 11 may be mounted onto the portable bathroom 1. This arrangement ensures physical proximity of the reserve power storage 11 to relevant electrical components. The primary power supply 6 and the plurality of lights 7 may be electrically connected to the reserve power storage 11. Thus, the reserve power storage 11 may both store power from the primary power supply 6 and provide necessary electrical power to the plurality of lights 7.

The at least one internal light 9 must be capable of sufficiently illuminating the portable bathroom 1 to improve ease of use of the portable bathroom 1. To this end the at least one internal light 9 may be a plurality of internal lights. The plurality of internal lights may be a set or strip of lights connected in series or parallel that fully illuminate the bathroom enclosure 2. The plurality of internal lights may be distributed about an internal surface 3 of the bathroom enclosure 2, as shown in FIG. 3. In this way, the plurality of internal lights may illuminate the corners of the bathroom enclosure 2 during use.

The at least one internal light 9 may require fastening tools in order to remain in an appropriate position around the bathroom enclosure 2. To this end, the present invention may further comprise a plurality of fasteners 20, as shown in FIG. 3. The plurality of fasteners 20 relates to a set of any of a variety of connectors, including nails, screws, rivets, and more capable of joining the at least one internal light 9 to the bathroom enclosure 2. In an exemplary embodiment, the plurality of fasteners 20 is a set of pop rivets. The at least one internal light 9 may be attached onto the portable bathroom 1 by the plurality of fasteners 20. Thus, the plurality of internal lights may be securely positioned to illuminate the bathroom enclosure 2, preventing movement during transportation of the present invention.

Although the invention has been explained in relation to its preferred embodiment, it is to be understood that many other possible modifications and variations can be made without departing from the spirit and scope of the invention as hereinafter claimed.

What is claimed is:

1. An illuminated portable bathroom comprising:
a portable bathroom;
an illumination system;
a handle;
the portable bathroom comprising a bathroom enclosure and a bathroom door;
the illumination system comprising a primary power supply and a plurality of lights;
the plurality of lights comprising at least one handle light and at least one internal light;
the bathroom door being hingedly connected to the bathroom enclosure;
the handle being mounted onto the bathroom door;
the plurality of lights being connected onto the portable bathroom;
the at least one handle light being positioned adjacent to the handle;
an emission axis of the at least one handle light being oriented towards the handle;
the at least one internal light being positioned within the bathroom enclosure;
the primary power supply being mounted onto the portable bathroom; and
the primary power supply being electrically connected to the plurality of lights.

2. The illuminated portable bathroom as claimed in claim 1 comprising:
the primary power supply being a plurality of solar panels;
the plurality of solar panels being externally mounted to the bathroom enclosure; and
each of the plurality of solar panels being oriented at an optimum solar angle from the portable bathroom.

3. The illuminated portable bathroom as claimed in claim 1, wherein the plurality of lights is a plurality of light-emitting diodes (LEDs).

4. The illuminated portable bathroom as claimed in claim 1 comprising:
a locking mechanism;
the locking mechanism comprising a first locking portion and a second locking portion;
the first locking portion being integrated into the bathroom door;
the second locking portion being integrated into the bathroom enclosure; and
the first locking portion and the second locking portion being selectively engaged to each other.

5. The illuminated portable bathroom as claimed in claim 4 comprising:
the locking mechanism further comprising an occupancy indicator;
the occupancy indicator being mounted onto the bathroom door; and
the occupancy indicator being operatively integrated into the first locking portion.

6. The illuminated portable bathroom as claimed in claim 1 comprising:
the plurality of lights further comprising a plurality of illumination shields; and
each of the plurality of illumination shields being mounted adjacent to a corresponding light of the plurality of lights.

7. The illuminated portable bathroom as claimed in claim 1 comprising:
a rigid member;
a light wiring;
the primary power supply being terminally mounted to the rigid member;
the at least one internal light being terminally mounted to the rigid member, opposite to the primary power supply;
the rigid member traversing through the bathroom door;
the light wiring being positioned through the rigid member; and
the primary power supply being electrically connected to the at least one internal light by the light wiring.

8. The illuminated portable bathroom as claimed in claim 1 comprising:
the illumination system further comprising a reserve power storage;
the reserve power storage being mounted onto the portable bathroom; and
the primary power supply and the plurality of lights being electrically connected to the reserve power storage.

9. The illuminated portable bathroom as claimed in claim 1 comprising:
the at least one internal light being a plurality of internal lights; and
the plurality of internal lights being distributed about an internal surface of the bathroom enclosure.

10. The illuminated portable bathroom as claimed in claim 1 comprising:
a plurality of fasteners; and
the at least one internal light being attached onto the portable bathroom by the plurality of fasteners.

11. An illuminated portable bathroom comprising:
a portable bathroom;
an illumination system;
a handle;
a locking mechanism;
a rigid member;
a light wiring;
the portable bathroom comprising a bathroom enclosure and a bathroom door;
the illumination system comprising a primary power supply and a plurality of lights;
the plurality of lights comprising at least one handle light and at least one internal light;
the locking mechanism comprising a first locking portion, a second locking portion, and an occupancy indicator;
the bathroom door being hingedly connected to the bathroom enclosure;
the handle being mounted onto the bathroom door;
the plurality of lights being connected onto the portable bathroom;
the at least one handle light being positioned adjacent to the handle;
an emission axis of the at least one handle light being oriented towards the handle;
the at least one internal light being positioned within the bathroom enclosure;
the primary power supply being mounted onto the portable bathroom;
the primary power supply being electrically connected to the plurality of lights;
the first locking portion being integrated into the bathroom door;
the second locking portion being integrated into the bathroom enclosure;
the first locking portion and the second locking portion being selectively engaged to each other;
the primary power supply being terminally mounted to the rigid member;
the at least one internal light being terminally mounted to the rigid member, opposite to the primary power supply;
the rigid member traversing through the bathroom door;
the light wiring being positioned through the rigid member;
the primary power supply being electrically connected to the at least one internal light by the light wiring;
the occupancy indicator being mounted onto the bathroom door; and
the occupancy indicator being operatively integrated into the first locking portion.

12. The illuminated portable bathroom as claimed in claim 11 comprising:
the primary power supply being a plurality of solar panels;
the plurality of solar panels being externally mounted to the bathroom enclosure; and
each of the plurality of solar panels being oriented at an optimum solar angle from the portable bathroom.

13. The illuminated portable bathroom as claimed in claim 11, wherein the plurality of lights is a plurality of LEDs.

14. The illuminated portable bathroom as claimed in claim 11 comprising:
the plurality of lights further comprising a plurality of illumination shields; and
each of the plurality of illumination shields being mounted adjacent to a corresponding light of the plurality of lights.

15. The illuminated portable bathroom as claimed in claim 11 comprising:
the illumination system further comprising a reserve power storage;
the reserve power storage being mounted onto the portable bathroom; and
the primary power supply and the plurality of lights being electrically connected to the reserve power storage.

16. The illuminated portable bathroom as claimed in claim 11 comprising:
the at least one internal light being a plurality of internal lights; and
the plurality of internal lights being distributed about an internal surface of the bathroom enclosure.

17. The illuminated portable bathroom as claimed in claim 11 comprising:
a plurality of fasteners; and
the at least one internal light being attached onto the portable bathroom by the plurality of fasteners.

18. An illuminated portable bathroom comprising:
a portable bathroom;
an illumination system;
a handle;
a locking mechanism;
a rigid member;
a light wiring;
a plurality of fasteners;
the portable bathroom comprising a bathroom enclosure and a bathroom door;
the illumination system comprising a primary power supply, a plurality of lights, and a reserve power storage;
the plurality of lights comprising at least one handle light, at least one internal light, and a plurality of illumination shields;
the locking mechanism comprising a first locking portion, a second locking portion, and an occupancy indicator;
the bathroom door being hingedly connected to the bathroom enclosure;
the handle being mounted onto the bathroom door;
the plurality of lights being connected onto the portable bathroom;
the at least one handle light being positioned adjacent to the handle;
an emission axis of the at least one handle light being oriented towards the handle;
the at least one internal light being positioned within the bathroom enclosure;
the primary power supply being mounted onto the portable bathroom;
the primary power supply being electrically connected to the plurality of lights;
the first locking portion being integrated into the bathroom door;
the second locking portion being integrated into the bathroom enclosure;
the first locking portion and the second locking portion being selectively engaged to each other;
the primary power supply being terminally mounted to the rigid member;
the at least one internal light being terminally mounted to the rigid member, opposite to the primary power supply;
the rigid member traversing through the bathroom door;
the light wiring being positioned through the rigid member;
the primary power supply being electrically connected to the at least one internal light by the light wiring;
the occupancy indicator being mounted onto the bathroom door;
the occupancy indicator being operatively integrated into the first locking portion;
each of the plurality of illumination shields being mounted adjacent to a corresponding light of the plurality of lights;
the reserve power storage being mounted onto the portable bathroom;
the primary power supply and the plurality of lights being electrically connected to the reserve power storage;
the at least one internal light being a plurality of internal lights;
the plurality of internal lights being distributed about an internal surface of the bathroom enclosure; and
the at least one internal light being attached onto the portable bathroom by the plurality of fasteners.

19. The illuminated portable bathroom as claimed in claim 18 comprising:
the primary power supply being a plurality of solar panels;
the plurality of solar panels being externally mounted to the bathroom enclosure; and
each of the plurality of solar panels being oriented at an optimum solar angle from the portable bathroom.

20. The illuminated portable bathroom as claimed in claim 18, wherein the plurality of lights is a plurality of LEDs.
